(19) United States
(12) Patent Application Publication
(10) Pub. No.: US 2016/0082944 A1
(43) Pub. Date: Mar. 24, 2016

(54) Apparatus and Method for Controlling Driving of Hybrid Vehicle

(71) Applicants: Hyundai Motor Company, Seoul (KR); Kia Motors Corporation, Seoul (KR)

(72) Inventors: Il Kwon PARK, Seoul (KR); Dong Jun Shin, Suwon-si (KR); In Eok Cho, Incheon (KR); Hoon Han, Hwaseong-Si (KR); Yong Kak Choi, Seoul (KR)

(73) Assignees: Hyundai Motor Company, Seoul (KR); Kia Motors Corporation, Seoul (KR)

(21) Appl. No.: 14/554,874

(22) Filed: Nov. 26, 2014

(30) Foreign Application Priority Data
Sep. 18, 2014 (KR) 10-2014-0124543

(51) Int. Cl. B60W 20/00; B60W 10/02; B60W 10/08; B60W 10/06

(52) U.S. Cl. CPC B60W 20/10; B60W 10/06; B60W 10/02; B60W 20/40; B60W 10/08; B60W 2510/082; B60W 2710/06; B60W 2710/021; Y10S 903/93

(57) ABSTRACT

Disclosed are apparatuses and methods for controlling driving of a hybrid vehicle. A method may include calculating a rate-of-change of a motor rpm, calculating a second reference rpm depending on the calculated rate-of-change of the motor rpm by varying a first reference rpm that has been set to engage an engine clutch, where the second reference rpm is newly set to engage the engine clutch, and controlling a vehicle drive mode by determining whether to start an engine and engage the engine clutch according to whether the motor rpm reaches the second reference rpm.

### CROSS REFERENCE TO RELATED APPLICATION

The present application claims priority of Korean Patent Application Number 10-2014-0124543 filed on Sep. 18, 2014, the entire contents of which application are incorporated herein for all purposes by this reference.

### BACKGROUND OF THE INVENTION

1. Field of the Invention

The present invention relates, generally, to a drive control technology for a hybrid vehicle and, more particularly, to a method and apparatus for controlling driving of a hybrid vehicle, which avoid a frequent engine start and attempt for an engine clutch engagement by varying an engine start point and engine clutch engagement point, depending upon the behavior of a motor in terms of rpm, and thus, improve fuel efficiency and vehicle operability.

2. Description of the Related Art

Parallel type architectures for a hybrid vehicle are classified by a mounting position of a motor into FMED (Flywheel Mounted Electric Device) type and TMED (Transmission Mounted Electric Device) type.

FIGS. 1A-1D illustrate power-flow according to a drive mode in a TMED type hybrid system, and the hybrid system can be driven in one drive mode from among an EV mode, Parallel mode, Series mode, and Slip mode. In addition, an HCU (Hybrid Control Unit) selects a drive mode depending upon a vehicle status and power requirement of a driver.

For example, in the EV mode, when a vehicle starts or is driven at a low speed, the vehicle only uses motor power by disengaging an engine clutch installed between an engine and a motor and delivering motor torque to a wheel.

Also, in Parallel mode, a vehicle is driven using both engine power and motor power, controlled to smoothly connect a motor with an engine by the processes of: starting the engine, synchronizing the engine revolutions and motor revolutions, and engaging an engine clutch, to prevent a large shock when engine power is connected by changing a mode from EV mode to HEV mode.

FIG. 2 describes behavior of a motor and engine when a mode is changed from EV mode to Parallel mode as the above, and it will be more specifically described referring to the accompanying drawing.

An engine is started when power requirement of a driver is a reference power (P1) or more.

Also, when the engine is started, if a motor rpm is a reference rpm (R1) or more, an engine clutch is engaged and a vehicle is driven in Parallel mode, the reference rpm (R1) being set for an engine clutch engagement.

In other words, if power requirement is the reference power (P1) or more, an engine is started regardless of whether an engine clutch can be engaged or not, and the engine clutch engagement is attempted.

However, as shown in FIG. 3, when a motor rpm does not reach the reference rpm (R1), an attempt for engaging an engine clutch is released, and a vehicle is driven in Slip mode or Series mode.

Consequently, as shown in FIG. 3, if power requirement of a driver decreases and a motor rpm does not reach the reference rpm (R1), unnecessary engine start occurs regardless of whether an engine clutch can be engaged or not, and thus fuel efficiency decreases. Also, operability deteriorates due to frequent attempts for engagement and disengagement of the engine clutch.

If a reference power (P1), which is a reference for Parallel mode, is set to a higher value to avoid unnecessary engine start and frequent engagement/disengagement of an engine clutch, a vehicle is driven in EV mode until power requirement of a driver reaches the elevated reference power (P1).

However, if a driving in a region where power requirement of a driver is less than the elevated reference power (P1), like urban driving, is repeated, driving in EV mode is continuously maintained. It leads to a decrease in SOC, and thus idle charging is required during a stop, which decreases fuel efficiency.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

Accordingly, the present invention has been made keeping in mind the above problems occurring in the prior art and/or other problems, and the present invention is to provide methods and apparatuses for controlling the driving of a hybrid vehicle, which avoid a frequent engine start and attempt for an engine clutch engagement by varying an engine start point and engine clutch engagement point depending on the behavior of the motor rpm and thus, improve fuel efficiency and vehicle operability.

According to various aspects, a method of the present invention may include a rate-of-change calculation step for calculating a rate-of-change of a motor rpm; a reference rpm calculation step for calculating a second reference rpm depending on the calculated rate-of-change of the motor rpm, by varying a first reference rpm that has been set to engage an engine clutch, the second reference rpm being newly set to engage the engine clutch; a drive mode control step for controlling a vehicle drive mode by determining whether to start an engine and engage the engine clutch according to whether the motor rpm reaches the second reference rpm.

The reference rpm calculation step may calculate the second reference rpm by applying a compensation value for the rate-of-change of the motor rpm to the first reference rpm. The compensation value may be proportional to the rate-of-change of the motor rpm.

In an aspect, the method of the present invention may further include a determination step for determining power requirement of a driver. If the power requirement is equal to or less than a reference power, the vehicle is controlled to be driven in an EV mode, and if the power requirement is more than the reference power, the vehicle is controlled to enter the rate-of-change calculation step for calculating the rate-of-change of the motor rpm.

In the drive mode control step, if the motor rpm is equal to or more than the second reference rpm, the vehicle may be controlled to be driven to be driven using motor and engine power by starting the engine and engaging the engine clutch.

In the drive mode control step, if the motor rpm is less than the second reference rpm and SOC (State Of Charge) is equal to or more than a first reference value, the vehicle may be controlled to be driven using motor power.

In the drive mode control step, if the motor rpm is less than the second reference rpm and the SOC is less than a first reference value, the vehicle may be controlled to start the engine, to select the drive mode from either a Series mode or a Slip mode according to whether the SOC reaches a second reference value, and to be driven in the selected mode.

If the SOC is equal to or more than the second reference value, the vehicle may be controlled to be driven in the Series mode, which drives the vehicle using motor power and charges a battery with engine power. If the SOC less than the second reference value, the vehicle may be controlled to be driven in the Slip mode, which carries out a slip control of the engine clutch and drives the vehicle using engine power.

According to various aspects, an apparatus of the present invention may include: a calculation unit for calculating a rate-of-change of a motor rpm and calculating a second reference rpm depending on the calculated rate-of-change of the motor rpm, by varying a first reference rpm which has been set to engage an engine clutch, the second reference rpm being newly set to engage the engine clutch; a storage unit for storing the first reference rpm and the second reference rpm; and a drive control unit for controlling a vehicle drive mode by determining whether to start an engine and engage the engine clutch according to whether the motor rpm reaches the second reference rpm.

According to various other aspects, an apparatus of the present invention may include: a control unit for calculating a rate-of-change of a motor rpm; calculating a second reference rpm to engage an engine clutch according to the calculated rate-of-change of the motor rpm by varying a first reference rpm that has been set to engage an engine clutch; storing the first reference rpm and the second reference rpm; and controlling a vehicle drive mode by determining whether to start an engine and engage the engine clutch according to whether the motor rpm reaches the second reference rpm.

The present invention may estimate behavior of a motor rpm by calculating a rate-of-change of the motor rpm and early determine if an engine clutch engagement is possible, and thus make a reference power be set to a lower value even at lower vehicle speeds. It allows a vehicle to be driven early on in Parallel mode and to maintain a high SOC. Consequently, the vehicle can be driven in EV mode in a region in which engine start is unnecessary, and as idle charging during a stop may be avoided, fuel efficiency is increased in urban driving.

Also, it is available to reduce harmful gas emissions from engine start by decreasing the number of engine start. In addition, decreasing a frequent engine start and engine clutch engagement/disengagement contributes to decrease in frequency of oscillation occurrence of a vehicle, therefore merchantable quality of the vehicle is improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A, FIG. 1B, FIG. 1C and FIG. 1D are views illustrating power-flow according to a drive mode in a TMED type hybrid system.

FIG. 2 is a view for describing behavior of a motor and engine and an engine clutch engagement point when a mode is changed from EV mode of FIG. 1A to Parallel mode of FIG. 1B.

FIG. 3 is a view for describing behavior of a motor and engine in case a motor rpm does not reach a reference rpm when a mode is changed from EV mode of FIG. 1A to Parallel mode of FIG. 1B.

FIG. 4 is a flow diagram for describing a control flow of an exemplary method for controlling driving of a hybrid vehicle according to the present invention.

FIG. 5 is a view for describing behavior of a motor and engine and an engine clutch engagement point according to a sudden increase in a rate-of-change of a motor rpm when a mode is changed from EV mode to Parallel mode in accordance with the present invention.

FIG. 6 is a view for describing behavior of a motor and engine and an engine clutch engagement point according to a steady increase in a rate-of-change of a motor rpm when a mode is changed from EV mode to Parallel mode in accordance with the present invention.

FIG. 7 is a schematic view of an exemplary apparatus for controlling driving of a hybrid vehicle according to the present invention.

### DESCRIPTION OF THE PREFERRED EMBODIMENTS

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A method for controlling driving of a hybrid vehicle according to various embodiments of the present invention is configured to include a rate-of-change calculation step (S10), a reference rpm calculation step (S20), and a drive mode control step (S30).

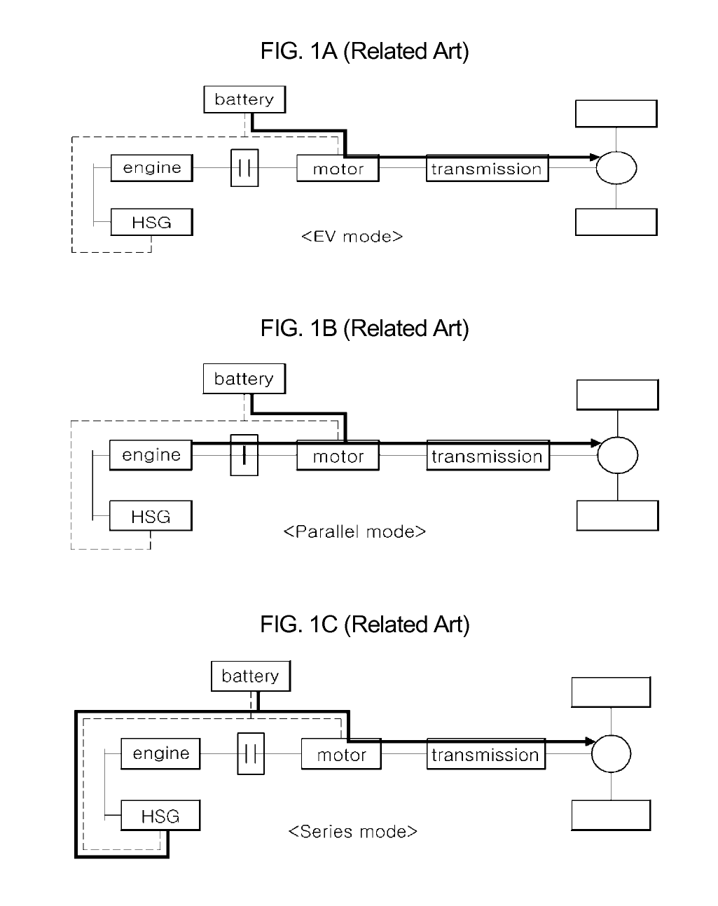

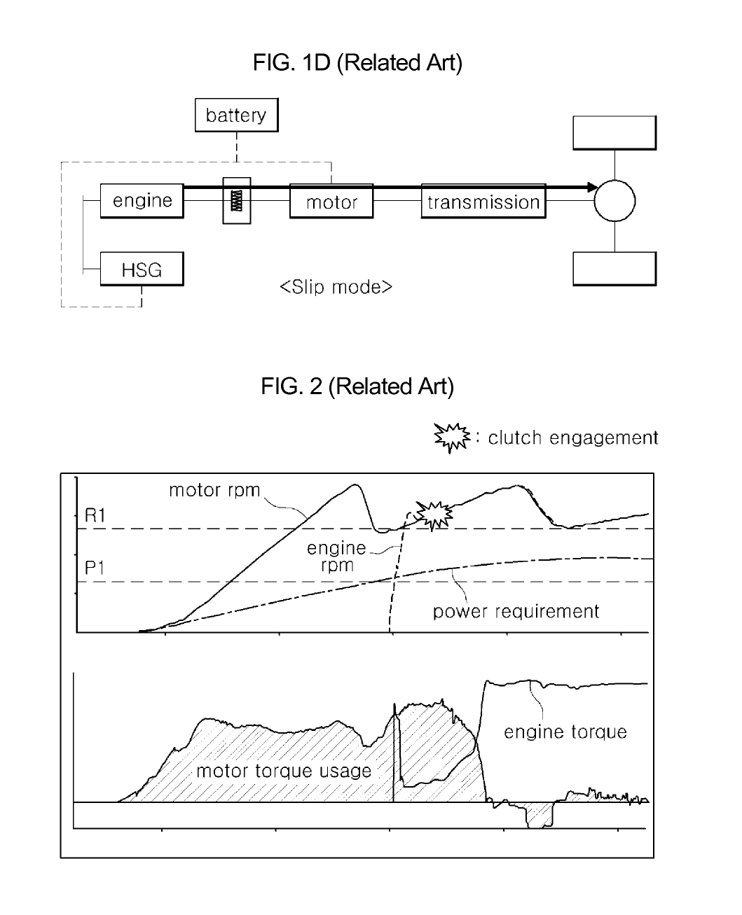

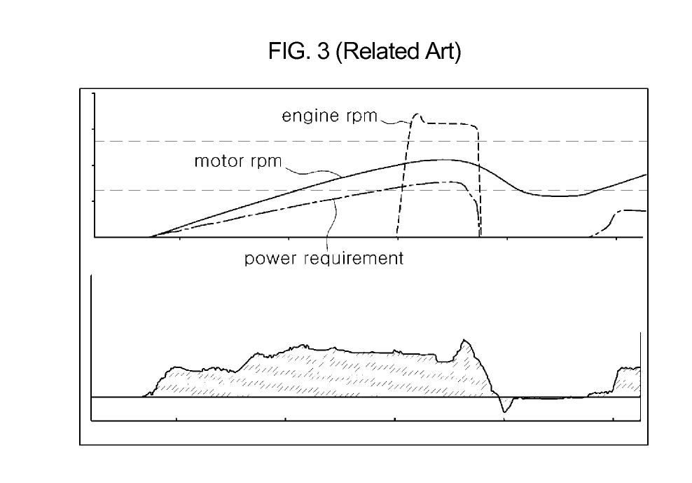

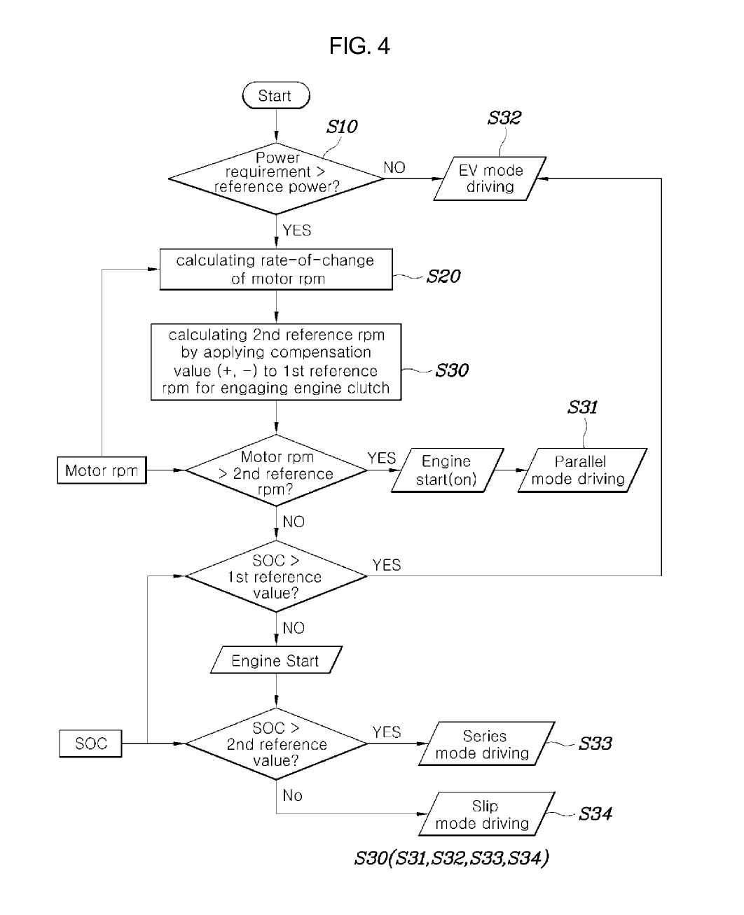

Referring to FIG. 4, first, a rate-of-change of a motor rpm (ΔM) is calculated in a rate-of-change calculation step (S10). For example, if a hybrid vehicle equipped with the present invention is a TMED type hybrid system as illustrated in FIG. 1, the rate-of-change of the motor rpm (ΔM) may be calculated using a variation in motor revolutions with respect to time when a vehicle starts, as the following calculation:

$$Δ M = \frac{d MotorRPM}{d T}$$

Specifically, in the reference rpm calculation step (S20), an engine clutch engagement point may be varied by estimating behavior of a motor rpm using the rate-of-change of the motor rpm (ΔM).

For example, a new reference rpm to engage an engine clutch, that is, a second reference rpm (S2) may be calculated depending on the calculated rate-of-change of the motor rpm (ΔM) by varying a first reference rpm (R1), which has been set to engage the engine clutch. The first reference rpm (R1) can be acquired using a 2-dimensional map forming a relation between an accelerator pedal sensor and degree of a slope.

Concretely, a second reference rpm (R2) is calculated by applying a compensation value (Rc) for the rate-of-change of the motor rpm (ΔM) to a first reference rpm (R1). The compensation value (Rc) is increased or decreased in proportional to the rate-of-change of the motor rpm (ΔM).

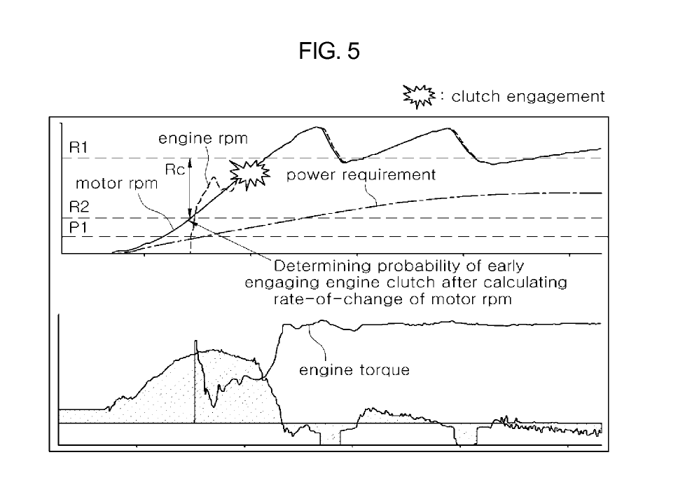

In other words, as shown in FIG. 5, when a variation in motor rpm increase is high, the motor rpm increases sharply, and it is estimated that an engine clutch is early engaged. Consequently, according to the calculated rate-of-change of the motor rpm (ΔM), a second reference rpm (R2), a new reference rpm for an engine clutch engagement, is calculated by applying a higher compensation value (Rc) corresponding to the sharply increased rate-of-change of the motor rpm (ΔM) to a first reference rpm (R1), which is previously set as the reference rpm for the engine clutch engagement.

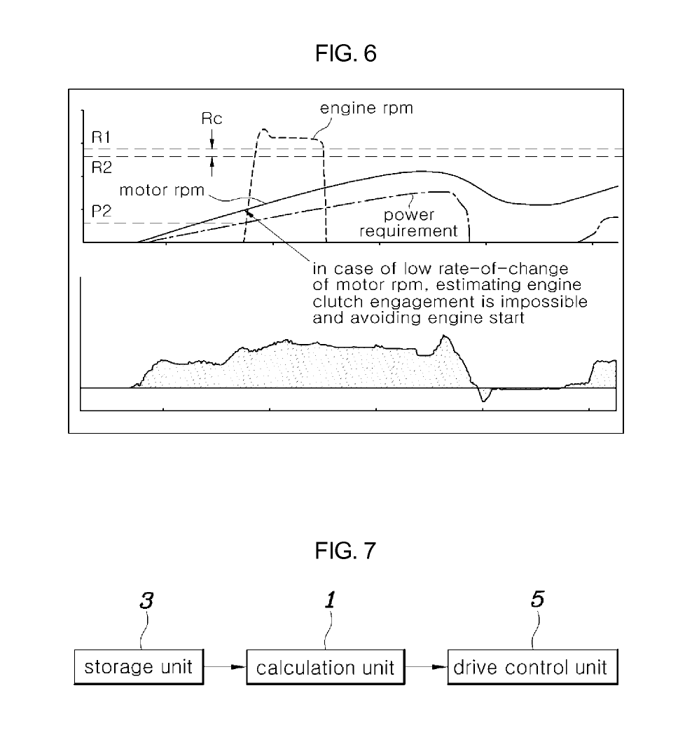

On the other hand, as shown in FIG. 6, when a variation in motor rpm increase is low, a motor rpm increases slowly, and little increase in a motor rpm is estimated. Consequently, according to the calculated rate-of-change of the motor rpm (ΔM), a second reference rpm (R2), a new reference rpm for an engine clutch engagement, is calculated by applying a lower compensation value (Rc) corresponding to the slowly increased rate-of-change of the motor rpm (ΔM) to a first reference rpm (R1), which is previously set as the reference rpm for the engine clutch engagement.

Additionally, the present invention may be configured to further include a determination step for determining power requirement of a driver when a vehicle starts.

For example, when the power requirement of a driver is a reference power (P1) or less, a vehicle is controlled to drive in EV mode (S32) because motor power is enough to drive the vehicle.

On the other hand, when the power requirement of a driver is more than a reference power (P1), motor power may not meet the driver's demand and thus, a vehicle is controlled to enter the rate-of-change calculation step (S10) for calculating a rate-of-change of a motor rpm (ΔM).

The reference power (P1) may be maximum power to be able to drive a vehicle in EV mode without starting an engine.

Meanwhile, in the drive mode control step (S30), a vehicle is controlled so as to select a drive mode by determining engine start and engine clutch engagement according to whether the motor rpm reach the second reference rpm (R2).

Specifically, in the drive mode control step (S30), when the motor rpm is the second reference rpm (R2) or more, a vehicle is controlled to be driven in Parallel mode (S31), which uses motor and engine power by starting an engine and engaging an engine clutch.

In other words, as shown in FIG. 5, when a rate-of-change of a motor rpm (ΔM) sharply increases, because of a compensation value corresponding to the rate-of-change (ΔM), a second reference rpm (R2) is set to a relatively lower value as the rate-of-change of the motor rpm (ΔM) is higher.

Consequently, when a motor rpm reaches the second reference rpm (R2) that has been set to a relatively lower value, a reference power (P1) can be set to a lower value even in low speed region, and a vehicle may be driven early on in Parallel mode. Thus, high SOC (State Of Charge) is maintained, and as a vehicle can be driven in EV mode in which engine start is unnecessary, idle charging may be avoided during a stop. As a result, fuel efficiency increases in urban driving.

On the other hand, in the drive mode control step (S30), when the motor rpm is less than the second reference rpm (R2), a SOC is compared with a first reference value. If the SOC is the first reference value or more, a vehicle is controlled to be driven in EV mode, which drives the vehicle using motor power (S32).

The first reference value may be SOC in which a vehicle can be driven in EV mode without starting an engine.

In other words, though power requirement of a driver reaches the reference power (P1), if a rate-of-change of a motor rpm increase (ΔM) is relatively low, a motor rpm is also little increased. Also, as a compensation value (Rc) corresponding to the rate-of-change (ΔM) is lower, the second reference rpm (R2) is set to a relatively higher value.

Consequently, without unnecessary engine start or attempt for an engine clutch engagement, a vehicle is driven in EV mode on the assumption that a SOC is enough to drive the vehicle in EV mode. Therefore, idle charging is avoided during a stop and unnecessary engine start is prevented during a driving, which reduces fuel consumption and increases fuel efficiency in urban driving.

Additionally, it is available to reduce harmful gas emissions from engine start by decreasing the times of engine start and to improve merchantable quality of a vehicle by decrease in frequency of oscillation occurrence of the vehicle attributable to decreasing a frequent engine start and the engine clutch engagement/disengagement.

Also, in the drive mode control step (S30), if the motor rpm is less than the second reference rpm (R2) and SOC is less than a first reference value, a vehicle is controlled to start an engine; to select either Series mode or Slip mode by whether the SOC reach the second reference value; and to be driven in the selected mode.

The second reference value may be a SOC in which a vehicle cannot be driven in EV mode due to the SOC, the second reference value being lower than the first reference value.

In detail, if the SOC is the second reference value or more, a vehicle is controlled to be driven in Series mode, which drives the vehicle using motor power, while charging a battery using engine power (S33).

Also, the SOC is less than the second reference value, a vehicle may be controlled to be driven in Slip mode, which carries out a slip control of an engine clutch and drive the vehicle using engine power (S34).

Meanwhile, an apparatus for controlling driving of a hybrid vehicle is configured to include a calculation unit 1, a storage unit 3, and a drive control unit 5.

Referring to FIG. 7, the calculation unit 1 is configured to calculate a rate-of-change of a motor rpm (ΔM) and to calculate a second reference rpm (R2) depending on the calculated rate-of-change of motor rpm (ΔM) by varying the first reference rpm (R1) that has been set to engage an engine clutch, the second reference rpm (R2) being newly set to engage the engine clutch.

Also, the storage unit 3 is configured to store the first reference rpm (R1) and second reference rpm (R2). A reference power (P1) that is used to compare with power requirement may be also stored in the storage unit 3.

Also, the drive control unit 5 is configured to select a vehicle drive mode by determining engine start and engine clutch engagement according to whether the motor rpm reaches the second reference rpm (R2).

In some embodiments, an apparatus for controlling driving of a hybrid vehicle may be configured with one control unit to integrate all functions.

Concretely, in the control unit, a rate-of-change of a motor rpm (ΔM) is calculated; a second reference rpm (R2) to engage an engine clutch is calculated depending on the calculated rate-of-change of motor rpm (ΔM) by varying a first reference rpm (R1) that has been set to engage an engine clutch; the first reference rpm (R1) and second reference rpm (R2) are stored; and a vehicle is controlled to select a drive mode by determining engine start and engine clutch engagement according to whether the motor rpm reaches the second reference rpm (R2).

The control unit may be an HCU (Hybrid Control Unit).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling driving of a hybrid vehicle, comprising:
a rate-of-change calculation step for calculating a rate-of-change of a motor rpm;
a reference rpm calculation step for calculating a second reference rpm depending on the calculated rate-of-change of the motor rpm by varying a first reference rpm that has been set to engage an engine clutch, the second reference rpm being newly set to engage the engine clutch; and
a drive mode control step for controlling a vehicle drive mode by determining whether to start an engine and engage the engine clutch according to whether the motor rpm reaches the second reference rpm.

2. The method of claim 1, wherein the reference calculation step calculates the second reference rpm by applying a compensation value for the rate-of-change of the motor rpm to the first reference rpm.

3. The method of claim 2, wherein the compensation value is proportional to the rate-of-change of the motor rpm.

4. The method of claim 1, further comprising:
a determination step for determining power requirement of a driver, wherein
if the power requirement is equal to or less than a reference power, the vehicle is controlled to be driven in an EV mode, and
if the power requirement is more than the reference power, the vehicle is controlled to enter the rate-of-change calculation step for calculating the rate-of-change of the motor rpm.

5. The method of claim 1, wherein the drive mode control step, if the motor rpm is equal to or more than the second reference rpm, controls the vehicle to be driven using motor and engine power by starting the engine and engaging the engine clutch.

6. The method of claim 1, wherein the drive mode control step, if the motor rpm is less than the second reference rpm and SOC (State Of Charge) is equal to or more than a first reference value, controls the vehicle to be driven using motor power.

7. The method of claim 1, wherein the drive mode control step, if the motor rpm is less than the second reference rpm and the SOC is less than a first reference value, controls the vehicle to start the engine, to select the drive mode from either a Series mode or a Slip mode according to whether the SOC reaches a second reference value, and controls the vehicle to be driven in the selected mode.

8. The method of claim 7, wherein if the SOC is equal to or more than the second reference value, the vehicle is controlled to be driven in the Series mode, which drives the vehicle using motor power and charges a battery with engine power.

9. The method of claim 7, wherein if the SOC less than the second reference value, the vehicle is controlled to be driven in the Slip mode, which carries out a slip control of the engine clutch and drives the vehicle using engine power.

10. An apparatus for controlling driving of a hybrid vehicle, comprising:
a calculation unit for calculating a rate-of-change of a motor rpm and calculating a second reference rpm depending on the calculated rate-of-change of the motor rpm by varying a first reference rpm that has been set to engage an engine clutch, the second reference rpm being newly set to engage the engine clutch;
a storage unit for storing the first reference rpm and the second reference rpm; and
a drive control unit for controlling a vehicle drive mode by determining whether to start an engine and engage the engine clutch according to whether the motor rpm reaches the second reference rpm.

11. An apparatus for controlling the driving of a hybrid vehicle, comprising:
a control unit for calculating a rate-of-change of a motor rpm, calculating a second reference rpm to engage an engine clutch according to the calculated rate-of-change of the motor rpm by varying a first reference rpm that has been set to engage an engine clutch, storing the first reference rpm and the second reference rpm, and controlling a vehicle drive mode by determining whether to start an engine and engage the engine clutch according to whether the motor rpm reaches the second reference rpm.
